(19) United States
(12) Patent Application Publication
(10) Pub. No.: US 2009/0319955 A1
(43) Pub. Date: Dec. 24, 2009

(54) TECHNIQUES FOR A NAVIGATION BASED DESIGN TOOL

(75) Inventors: Alexander Malek, Seattle, WA (US); Alexander Tudor, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,797

(22) Filed: Jun. 20, 2008

(51) Int. Cl. G06F 3/048; G06F 17/30

(52) U.S. Cl. 715/854; 707/103 R; 707/E17.048

(57) ABSTRACT

Various technologies and techniques are disclosed for a navigation based design tool. Relationships between artifacts that are managed by a design tool are accessed. An initial view of the design tool is displayed with a default page showing categories of the artifacts based upon the relationships. A user can navigate page by page through a plurality of pages to manage one or more of the artifacts. The page by page navigation is enabled by using the relationships between the artifacts. As the user navigates page by page through the pages, a navigation history is displayed to illustrate a history of the pages that have been accessed.

### BACKGROUND

Software developers can create software using one or more software design tools, such as MICROSOFT® SharePoint Designer, MICROSOFT® Access, and MICROSOFT® Visual Studio. Such design tools tend to share a file-explorer based model for managing the artifacts they create. For example, a user typically opens a design tool and manages the artifacts using some sort of tree control. Artifacts can include any type of object that a particular design tool can create and manage, such as classes, forms, buttons, lists, etc. Double-clicking or otherwise selecting an artifact in the tree will typically open an editor for the item in a tabbed window, adjacent to the tree control. This tree control approach does not typically scale well to large numbers of different types of artifacts does not give users easy access to data regarding any related artifacts.

### SUMMARY

Various technologies and techniques are disclosed for a navigation based design tool. Relationships between artifacts that are managed by a design tool are accessed. An initial view of the design tool is displayed with a default page showing categories of the artifacts based upon the relationships. A user can navigate page by page through a plurality of pages to manage one or more of the artifacts. The page by page navigation is enabled by using the relationships between the artifacts. In one implementation, as the user navigates page by page through the pages, a navigation history is displayed to illustrate a history of the pages that have been accessed.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a process flow diagram for one implementation illustrating the stages involved in identifying relationships between artifacts and using the relationships in a design tool to allow a user to manage the artifacts.

FIG. 2 is a diagrammatic view for one implementation illustrating an exemplary series of relationships between artifacts.

FIG. 3 is a process flow diagram for one implementation illustrating the stages involved in using a design tool to navigate page to page through the relationships between artifacts to manage the artifacts as desired.

FIG. 4 is a diagrammatic view for one implementation illustrating an exemplary navigation order for navigating through pages of artifacts.

FIG. 5 is a simulated screen for one implementation that illustrates an example of a main navigation page that opens when a design tool is first launched.

FIG. 6 is a process flow diagram for one implementation illustrating the stages involved in navigating through category, summary, and editor pages to view and manage artifacts.

FIG. 7 is a process flow diagram for one implementation that illustrates the stages involved in tracking a navigation history as a user navigates through pages in the design tool.

FIG. 8 is a simulated screen for one implementation that illustrates an exemplary category page that shows multiple categories of artifacts.

FIG. 9 is a simulated screen for one implementation that illustrates an exemplary summary page for a selected artifact.

FIG. 10 is a simulated screen for one implementation that illustrates an exemplary editor page for a selected artifact as well as a navigation history and breadcrumb control.

FIG. 11 is a diagrammatic view of a computer system of one implementation.

### DETAILED DESCRIPTION

The technologies and techniques herein may be described in the general context as a design tool for managing artifacts, but the technologies and techniques also serve other purposes in addition to these. In one implementation, one or more of the techniques described herein can be implemented as features within a content management designer such as MICROSOFT® SharePoint Designer, from a software development program such as MICROSOFT® Visual Studio, or from any other type of program or service that offers design tools for creating artifacts or software.

In one implementation, techniques are described for a navigation-based design tool that allows users such as developers and designers to navigate through a series of pages to reach the desired artifacts. The term “design tool” as used herein is meant to include an integrated development environment or other type of designer that allows users to create and manage software or other applications that are later used by end users. The term “artifact” as used herein is meant to include any type of object or entity that is being managed by the design tool. A few non-limiting examples of artifacts can include source code files, objects, forms, lists, categories, etc.

Relationships between the artifacts are identified, and the design tool uses these relationships to allow the user to navigate among the pages in the hierarchy to reach the desired artifact that the user wishes to work on. In other words, the development environment in which the user works is navigated through a series of pages that are related to each other through a hierarchical relationship. As one non-limiting example, in the case of a content management application such as MICROSOFT® SharePoint Designer, a user may need to modify various settings for lists that can be created by end users, and for tasks that can be created by end users. The user can navigate the hierarchy of artifacts to access the various categories of artifacts that can be edited, select a particular lists artifact and navigate to a lists editor page, and then can quickly and easily navigate to the tasks artifact after he is finished with editing the lists artifact.

As another non-limiting example, suppose that the user is writing source code and user interface code using a design tool such as MICROSOFT® Visual Studio. Source code may be contained in multiple source code files, such as “A.vb”, “B.vb” and so on. If the source code file “A.vb” is called from a particular artifact elsewhere in the program, then the relationships that have been identified between the artifacts will allow the user to easily identify exactly which artifacts are calling or using “A.vb”, and also to navigate to those artifacts quickly to edit them as desired.

In one implementation, a navigation history is displayed so the user can visually see where he has previously navigated, and can easily return to an earlier section to continue working on that section. In another implementation, a breadcrumb control is described so that the user can identify and navigate among parents, siblings, and children of the currently open artifact. These concepts will now be described in detail in the figures that follow.

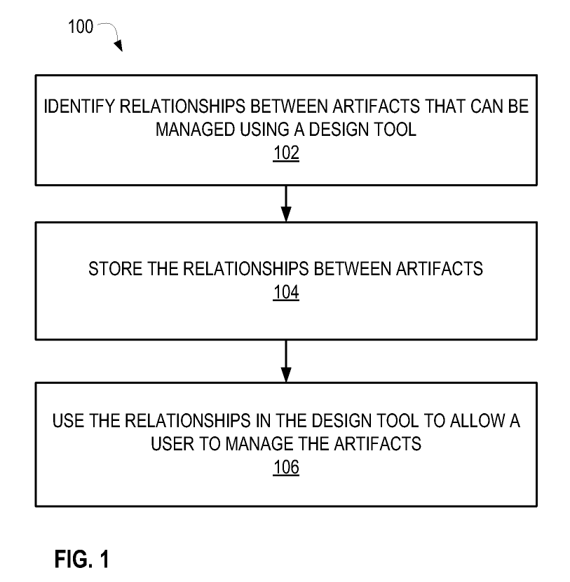

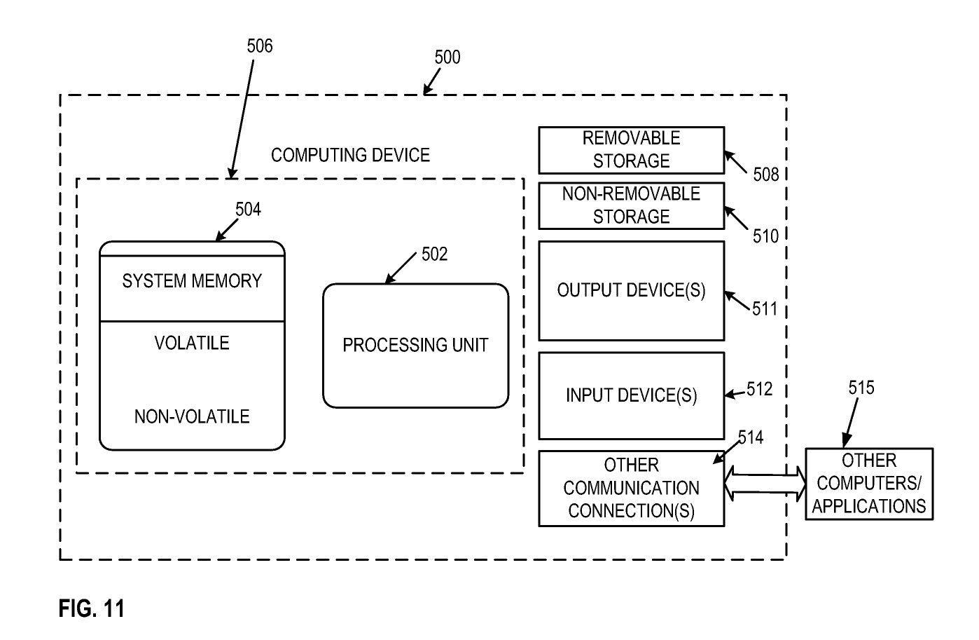

Turning now to FIGS. 1-10, the stages for implementing one or more implementations of a navigation-based design tool are described in further detail. In some implementations, the processes of FIG. 1-10 are at least partially implemented in the operating logic of computing device 500 (of FIG. 11).

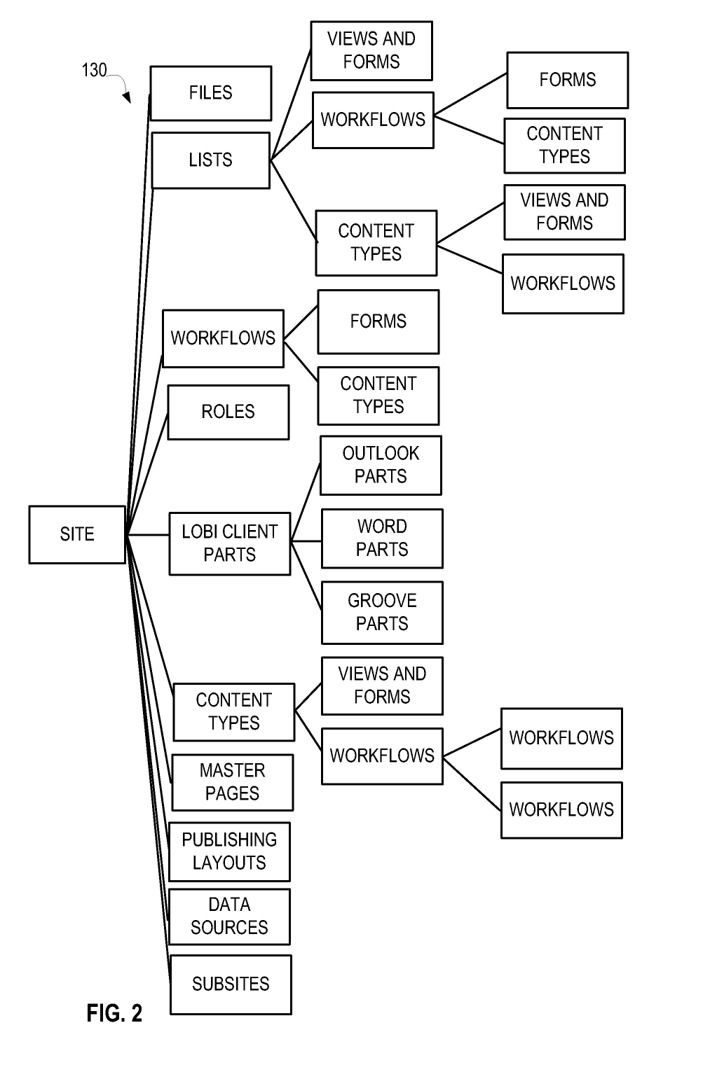

FIG. 1 is a process flow diagram 100 for one implementation illustrating the stages involved in identifying relationships between artifacts and using the relationships in a design tool to allow a user to manage the artifacts. Relationships are identified between artifacts that can be managed using a design tool (stage 102). The relationships between artifacts are stored (stage 104). In other words, the design tool keeps track of the various types of artifacts that the users can create and manage, and then maintains these relationships as instances of the artifacts are created by users. The relationships between artifacts are used in the design tool to allow a user to manage the artifacts (stage 106). One non-limiting example of how the relationships can be used in the design tool is to facilitate navigation between pages in the design tool, as is described in further in FIGS. 2-10. Another non-limiting example of how the relationships can be used in the design tool is to facilitate management of groups of artifacts, such as to delete or update all the workflows attached to the current list.

FIG. 2 is a diagrammatic view 130 for one implementation illustrating an exemplary series of relationships between artifacts. The diagram shown in FIG. 2 illustrates a hypothetical hierarchy that could be identified and used for a content management design tool such as MICROSOFT® SharePoint Designer. A content management site being managed by such a design tool could have one or more files, lists, workflows, master pages, etc. Lists could have content types, and content types could have views and forms, as well as workflows. The exact hierarchy of the artifacts can differ from system to system, but the point is that any relationships that exist between the artifacts can be identified and stored for use by the design tool, as described in FIG. 1.

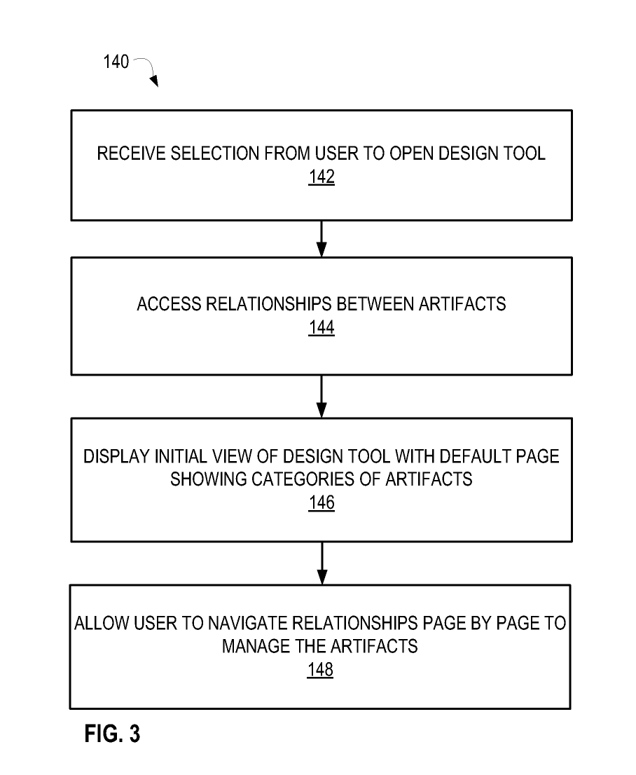

FIG. 3 is a process flow diagram 140 for one implementation illustrating the stages involved in using a design tool to navigate page to page through the relationships between artifacts to manage the artifacts as desired. A selection is received from a user to open a design tool (stage 142). The design tool accesses the relationships that exist between the artifacts (stage 144). An initial view of the design tool is displayed with a default page showing categories of artifacts (stage 146). The initial page can also contain other details about the application overall, such as application summary information, if applicable. The user can navigate the relationships page by page to manage the artifacts by selecting one of the categories of artifacts that are shown in the category list (stage 148).

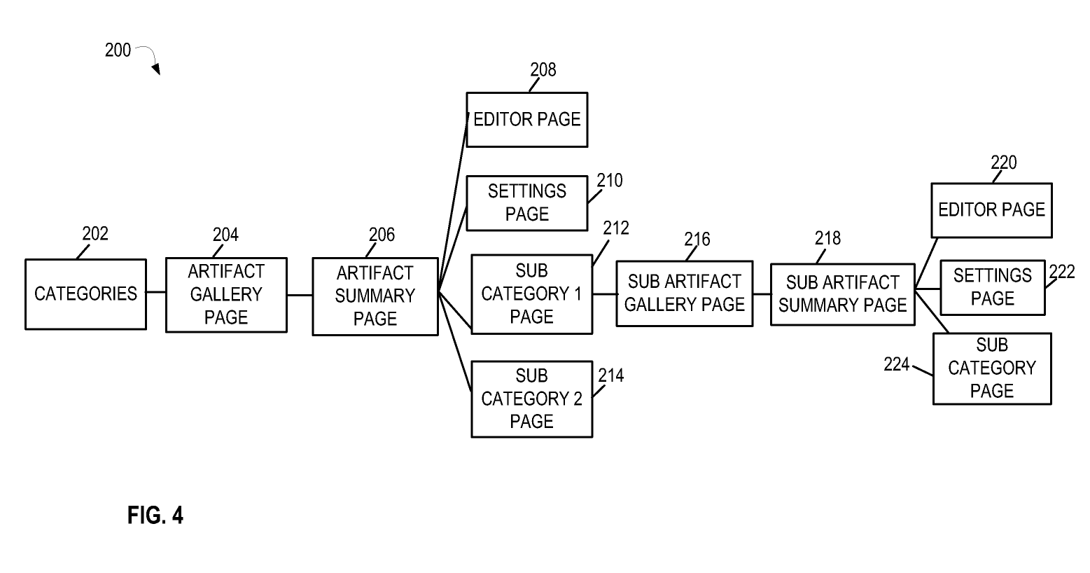

In one implementation, the pages can be navigated using a navigation pane, such as one displayed prominently on a left section of the screen. In one implementation, the user can minimize the navigation pane when he does not wish to see the navigation options. As the user interacts with the design tool to modify the artifacts, the relationships are maintained. For example, as new artifacts are created, the new relationships are saved and added to the list of relationships so that they can be navigated. FIGS. 4-10 illustrate how navigation between pages is performed through the relationships between the artifacts.

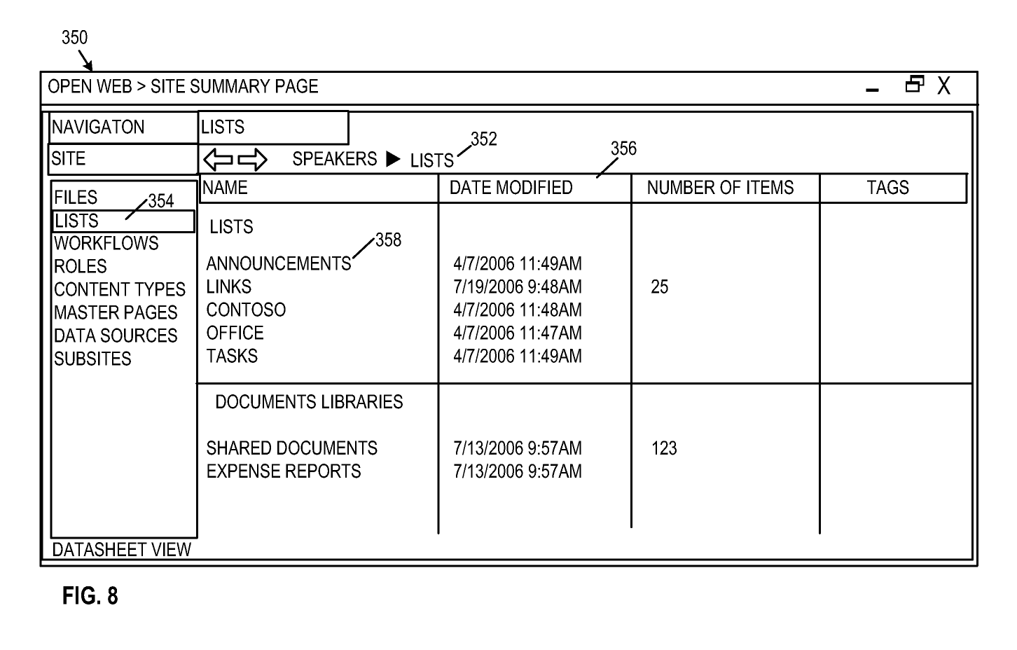

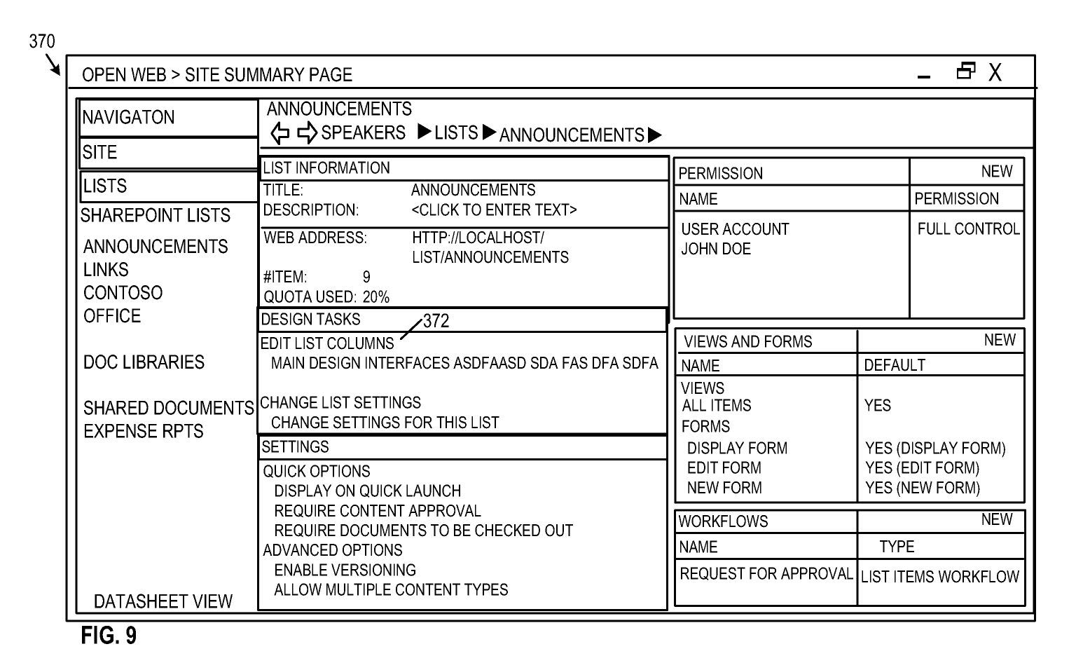

FIG. 4 is a diagrammatic view 200 for one implementation illustrating an exemplary navigation order for navigating through pages of artifacts. In the example shown, the page navigation starts with an initial page that lists various categories of artifacts 202. A user can select one of the categories to navigate to an artifact gallery page 204 and an artifact summary page 206. The term “artifact gallery page” as used herein is meant to include a page which shows an enumeration of all the instances of an artifact type. An example of an artifact gallery page is shown in FIG. 8. The term “artifact summary page” as used herein is meant to include a page which displays summary information about a selected artifact. A few non-limiting examples of the type of summary information that can be displayed on an artifact summary page include permissions applied to the current artifact, metadata, related artifacts, etc. An example of an artifact summary page is shown in FIG. 9.

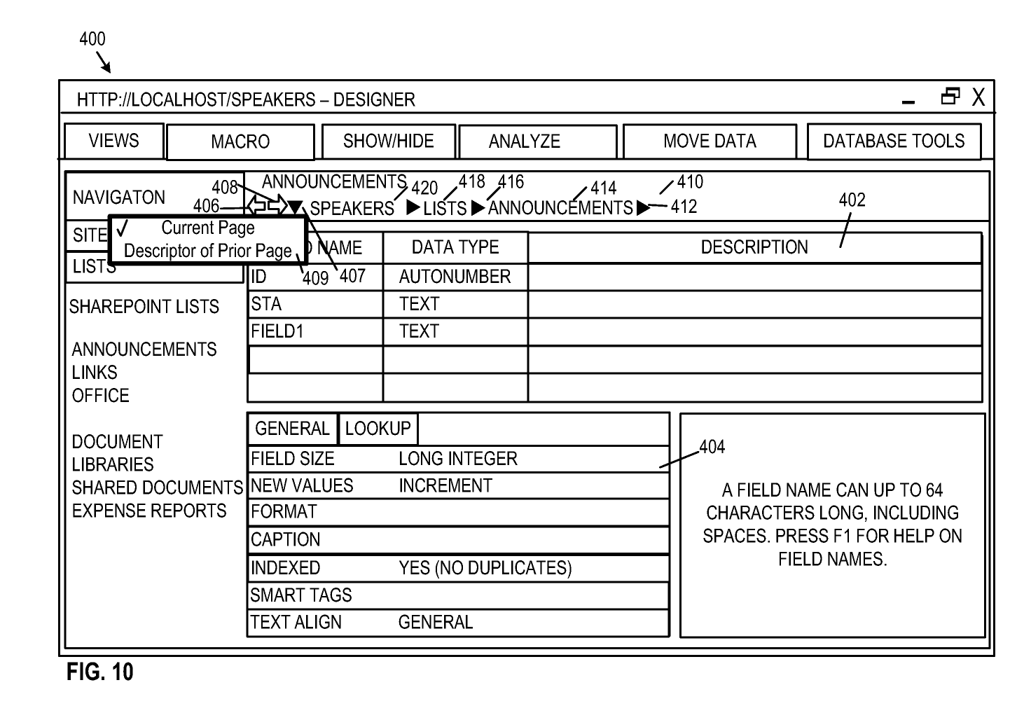

From an artifact summary page 206, the user can access an artifact editor page 208. The term “artifact editor page” as used herein is meant to include a page which allows a user to edit a selected artifact. An example of an artifact editor page is shown in FIG. 10. From the artifact summary page 206, the user can also access artifact settings page 210, and one or more sub-category pages (212 and 214). If the user selects a sub-category page 212, then corresponding pages for the sub-category can also be accessed, such as a gallery page 216, summary page 218, and then an editor page 220, settings page 222, or another sub-category page 224. This order is just for the sake of illustration, and numerous other variations of page orderings could be used. At any page in the process the user can cycle back around to yet another artifact, thus making dozens if not hundreds of different paths through the pages possible depending on the types of artifacts that are being managed by a particular design tool.

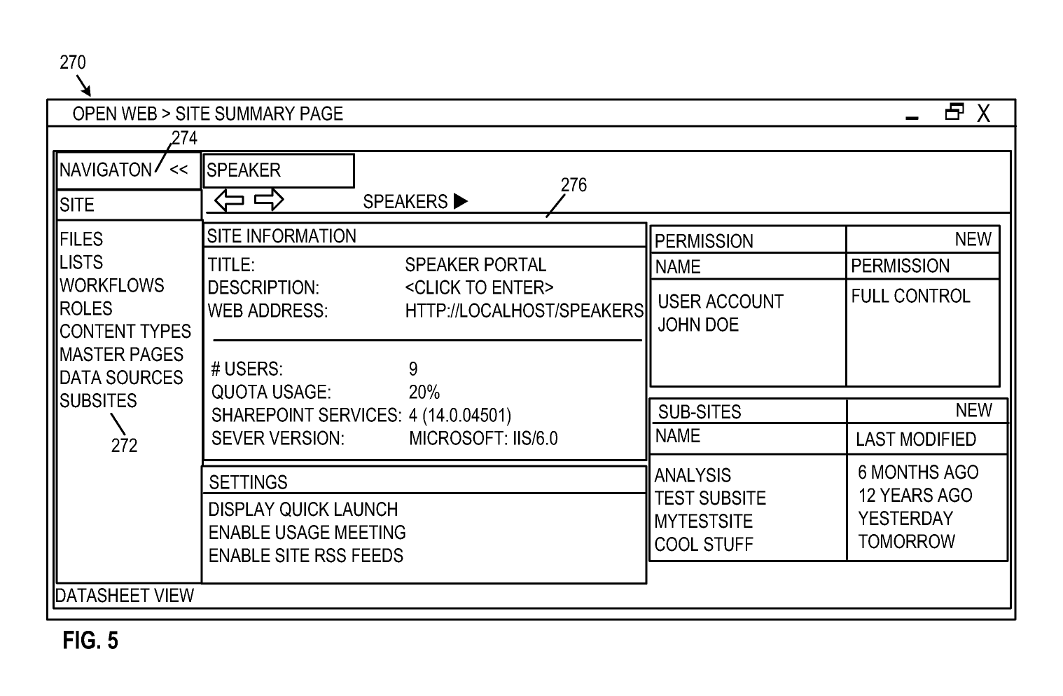

FIG. 5 is a simulated screen 270 for one implementation that illustrates an example of a main navigation page that opens when a design tool is first launched. The user can navigate through the various categories 272 shown in a navigation pane 274 in order to access more details about those categories, including the artifacts those categories contain. Some high level information about the overall application is displayed in the initial content area 276, but in other implementations, this could be other types of details.

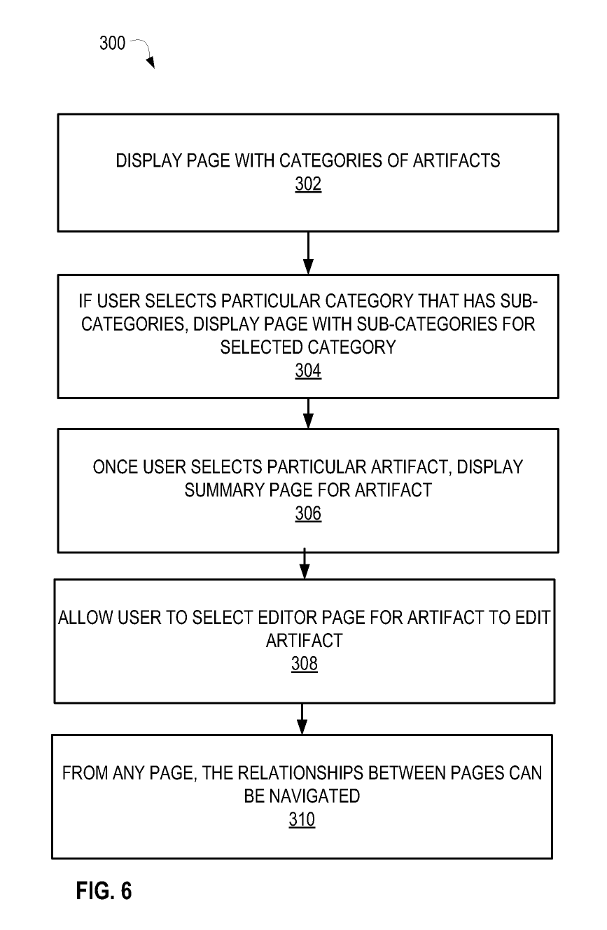

FIG. 6 is a process flow diagram 300 for one implementation illustrating the stages involved in navigating through category, summary, and editor pages to view and manage artifacts. A page is displayed with categories of artifacts within a design tool (stage 302). If the user selects a particular category that has sub-categories, then a page is displayed with the sub-categories for the selected category (stage 304). At any point in the hierarchy, when the user selects a particular artifact, then the summary page is displayed for that artifact (stage 306). The user can select an editor page for the artifact in order to edit the artifact (stage 308). From any page being displayed in the design tool, the relationships between pages can be navigated using the navigation hierarchy (stage 310).

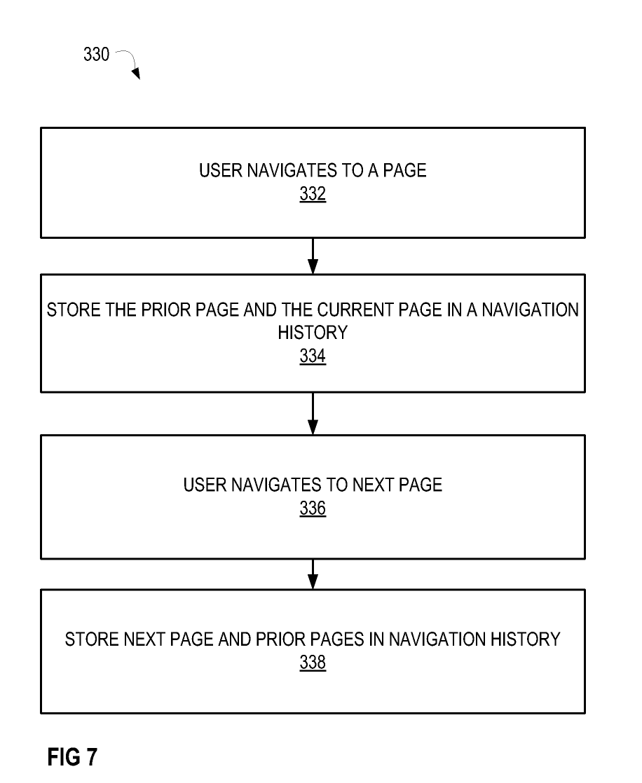

FIG. 7 is a process flow diagram 330 for one implementation that illustrates the stages involved in tracking a navigation history as a user navigates through pages in the design tool. When the user navigates to a page in the design tool (stage 332), the prior page and the current page are stored in a navigation history (stage 334). When the user navigates to the next page (stage 336), then the next page and the prior pages are stored in the navigation history (stage 338). In this fashion, the system tracks the path the user has taken in the design tool, and the user can quickly go back to an earlier path. A particular entry in the navigation history can be selected in order to navigate to that particular artifact, as illustrated in FIG. 10.

In one implementation, a breadcrumb control is provided instead of or in addition to a navigation history to allow the user to navigate among parent, sibling, and child artifacts to the currently displayed artifact. The term “breadcrumb control” as used herein is meant to include a feature that allows parent, sibling, and child artifacts to a current artifact to be navigated. The navigation history and breadcrumb control are both illustrated in further detail in FIG. 10.

FIG. 8 is a simulated screen 350 for one implementation that illustrates an exemplary gallery page that shows multiple categories of artifacts. In the example shown, the lists category 354 is selected, and the sub-categories for the lists category 354 are then showed in the content area 356. For example, there are various types of lists that have been defined for the content management application in this example, such as announcements, links, tasks, etc. If the announcements list is selected 358, then a screen similar to FIG. 9 is displayed.

FIG. 9 is a simulated screen 370 for one implementation that illustrates an exemplary summary page for a selected artifact. A summary page is sort of a “home” page for a selected artifact, and can include details such as a link to the main editor, a place to edit metadata, and galleries of related artifacts. In this example, the summary information is being displayed for the announcements artifact that was selected in the screen of FIG. 8. Various summary details about the announcements artifact are displayed, and the user can select one of the edit options displayed on the screen in order to edit the announcements list. For example, if the edit list columns option 372 is selected, then an editor page is shown that allows the user to edit the list columns for the announcements list. An example editor page for a selected artifact is shown in FIG. 10, which will be discussed next.

FIG. 10 is a simulated screen 400 for one implementation that illustrates an exemplary editor page for a selected artifact as well as a navigation history and breadcrumb control. In the example shown, the user selected the option on FIG. 9 to edit the list columns for the announcements list. Thus, the content area contains an editor for modifying the field names and data types 402, as well as other general details 404 about the list. Various other types of editing can be performed on an editor page for a selected artifact, depending on the type of artifact being edited.

As the user has navigated through the pages in the hierarchy, a navigation history has been tracked on the user interface display. From any of the pages that have been accessed for the artifacts, the navigation history can be used to navigate through the relationships and access other artifacts of interest. For example, the back navigation option 406 enables the user to navigate backwards in the navigation history, such as to the most recently accessed artifact, and so on to earlier artifacts that were accessed. In one implementation, the user can view a more detailed list of the prior artifacts by selecting a drop-down option 407 to access a list 409 containing the navigation history, and can then select a particular artifact from the list 409 in which to navigate to.

The forward navigation option 408 enables the user to navigate forward in the navigation history, such as to artifacts that were accessed after the current artifact being displayed. In one implementation, the user can view a more detailed list of the later artifacts by selecting drop-down option 407 to access list 409 containing the navigation history, and can then select a particular artifact from the list 409 in which to navigate to. In one implementation, forward navigation option 408 is only enabled after the user has selected the back navigation option 406 so there is a forward history.

A breadcrumb control 410 is also shown in FIG. 10 to enable the user to navigate among parents, siblings, and children to the currently open artifact. While the breadcrumb control 410 and navigation history (with back and forward navigation options) are shown together in FIG. 10, it will be appreciated that in other implementations, they can be used independently of one another. With respect to the breadcrumb control 410 in the example shown, the user is browsing a list called announcements. The breadcrumb that is displayed in the breadcrumb control 410 says:
Speakers→Lists→Announcements→

Upon clicking on the word Speakers 420 or Lists 418 in the breadcrumb control 410, the user could jump to either one of those pages, since they are a parent chain crumb. The user could also click on one of the arrows, such as arrow 416 (the arrow to the left of Announcements 414). Upon clicking arrow 416, a dropdown list with all of the siblings of Announcements 414 would be displayed. The user could select any one of the siblings in the list to jump to the selected sibling. The user could also click the arrow 412 to the right of Announcements 414 and view of the children pages of the announcements page.

As shown in FIG. 11, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 11 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 11 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for using page-based navigation to manage artifacts in a design tool comprising the steps of:
accessing relationships between artifacts that are managed by a design tool;
displaying an initial view of the design tool with a default page showing categories of the artifacts based upon the relationships; and
allowing a user to navigate page by page through a plurality of pages to manage one or more of the artifacts, the page by page navigation being enabled by using the relationships between the artifacts.

2. The method of claim 1, wherein the relationships are accessed upon receiving a selection from the user to open the design tool.

3. The method of claim 1, wherein the default page also shows summary information regarding an application currently being designed in the design tool.

4. The method of claim 1, wherein the design tool is a content management application designer.

5. The method of claim 1, wherein the design tool is a software development application.

6. The method of claim 1, further comprising the steps of:
displaying a navigation history of the pages to which the user has navigated using the relationships.

7. The method of claim 1, wherein at least one of the pages is an artifact gallery page.

8. The method of claim 1, wherein at least one of the pages is an artifact summary page.

9. The method of claim 1, wherein at least one of the pages is an artifact editor page.

10. A method for utilizing a navigation history in a design tool comprising the steps of:
allowing a user to navigate page by page through a plurality of pages to manage one or more of the artifacts, the page by page navigation being enabled by using relationships between the artifacts; and
as the user navigates page by page through the plurality of pages, displaying a navigation history to illustrate a history of the pages that have been accessed.

11. The method of claim 10, wherein a particular entry in the navigation history can be selected to navigate to that artifact.

12. The method of claim 10, wherein the user can navigate page by page using a navigation pane.

13. The method of claim 12, wherein the navigation pane is displayed prominently within the design tool.

14. The method of claim 12, wherein the navigation pane can be minimized by the user.

15. The method of claim 10, wherein the relationships between the artifacts are maintained as the user interacts with the design tool to modify the artifacts.

16. A computer-readable medium having computer-executable instructions for causing a computer to perform steps comprising:
identifying relationships between artifacts that can be managed using a design tool;
storing the relationships between artifacts; and
enabling a user to access the artifacts using the relationships between the artifacts.

17. The computer-readable medium of claim 16, wherein the design tool is operable to enable the user to access the artifacts through a navigation pane that is generated based upon the relationships.

18. The computer-readable medium of claim 16, wherein the design tool is operable to enable the user to navigate through the artifacts page by page using the relationships.

19. The computer-readable medium of claim 18, further having computer-executable instructions for causing a computer to perform steps comprising:
displaying a navigation history to illustrate a history of pages that have been accessed by the user in the design tool.

20. The computer-readable medium of claim 16, further having computer-executable instructions for causing a computer to perform steps comprising:
displaying a breadcrumb control that enables the user to visually see and navigate among recently accessed artifacts along with siblings to the recently accessed artifacts.
